(19) United States
(12) Patent Application Publication
(10) Pub. No.: US 2011/0057489 A1
(43) Pub. Date: Mar. 10, 2011

(54) INFANT CAR SEAT SYSTEM AND STRAP

(76) Inventor: Allen Greene, Raleigh, NC (US)

(21) Appl. No.: 12/877,350

(22) Filed: Sep. 8, 2010

Related U.S. Application Data
(60) Provisional application No. 61/240,701, filed on Sep. 9, 2009.

(51) Int. Cl. B60N 2/28

(52) U.S. Cl. 297/253; 297/250.1

(57) ABSTRACT

An infant seat system is shown and described. In one embodiment, the system includes an infant car seat (ICS) having a strap-interface; a strap interfaced with the ICS; a clip attached to strap; and a ratchet tightener (RT) positioned in between the clip and the infant seat for tightening the strap and securing the ICS quickly and easily.

### RELATED APPLICATION

This application claims priority to U.S. Patent Application No. 61/240,701, filed 9 Sep. 2010.

### TECHNOLOGY FIELD

The present disclosure relates generally to infant car seats. More particularly, the present disclosure relates to improvements in securing and releasing infant car seats.

### BACKGROUND

Infant car seats (also referred to herein as “ICSs”) are known in the art. FIG. 1, for example, illustrates an infant car seat 2 positioned on seat 4 of a vehicle, e.g., a car (not shown to facilitate viewing). Typically, ICSs are secured to the car using strap systems, e.g. 10 which connect to at least one anchor 12. In this depiction, anchor 12 is located between the junction created between base 4a and backrest 4b, but anchors can be located in other places. FIG. 2 shows a close up of strap system 10.

Strap system 10 includes clips 10a and 10b configured to attach to anchors. Oftentimes, system 10 will also include buckle 14 for tightening the strap of the system. Because of the variability in size and shape of different ICSs and different car seats, e.g., 4a and 4b, it is often necessary to insert spacers, e.g., 16a or 16b, in between the ICS and the car seat to create the proper ICS orientation. Spacers may be made of a variety of materials, but commonly include towels or polyethylene foam (e.g., pool noodles). Although spacers may be used when the seat is forward facing, as shown, they are also commonly used when the seat is reward facing. Applicant has found that the use of spacer materials may make it difficult to properly secure ICSs. Applicant has also found that in some instances, car seat configuration makes it difficult to secure ICSs. It is to these and additional problems that the instant inventions are directed.

### SUMMARY

By way of summary, the disclosure is directed to an infant seat system. In one embodiment, the system includes an infant car seat (ICS) having a strap-interface; a strap interfaced with the ICS; a clip attached to strap, wherein the clip is sized to interface with an anchor of the car; and a ratchet tightener (RT) positioned in between the clip and the infant seat for tightening the strap and securing the ICS quickly and easily.

In another embodiment, the invention is directed to the RT. In another embodiment, the invention is directed to the RT in combination with a strap. Other embodiments include other configurations and combinations of the system.

The above summary was intended to summarize certain embodiments of the present invention. Systems and methods of the present invention will be set forth in more detail in the figures and detailed description below. It will be apparent, however, that the detailed description is not intended to limit the present invention, the scope of which should be properly determined by the appended claims.

### BRIEF DESCRIPTION OF THE DRAWINGS

FIG. 1 shows related technology;

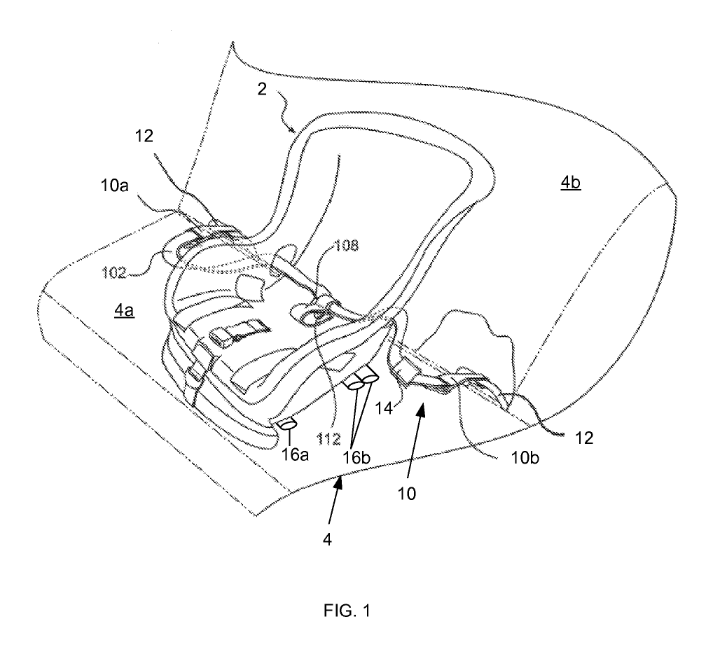

FIG. 2 shows a close up of a strap from FIG. 1;

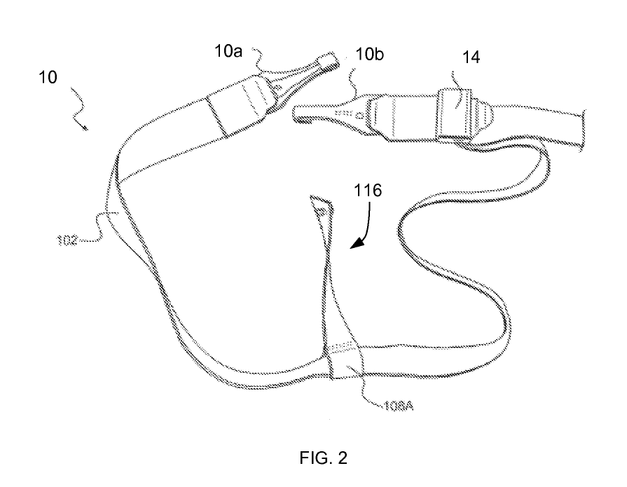

FIG. 3 shows one embodiment of a system according to the disclosure;

FIG. 4 shows a close up of a ratchet tightener;

FIG. 5 shows another embodiment of a ratchet tightener;

FIG. 6 shows a close up of a cover.

### DETAILED DESCRIPTION

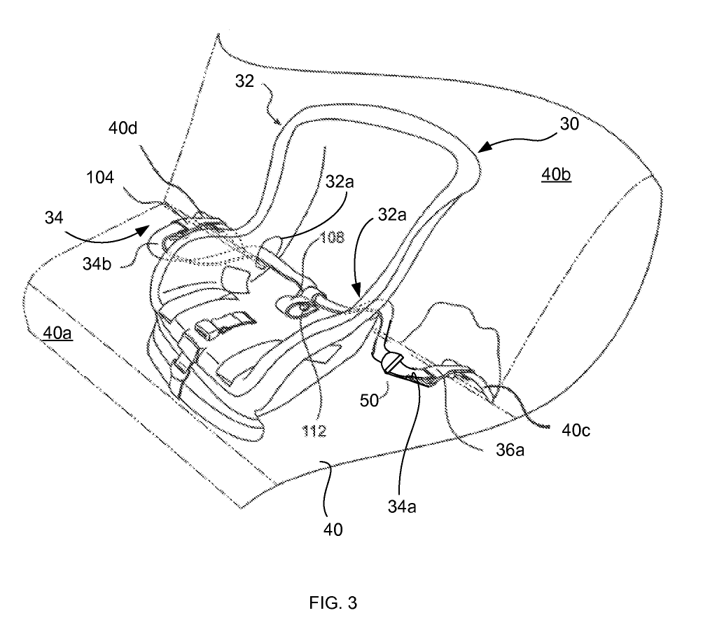

FIG. 3 shows one embodiment of an infant seat system 30 secured to seat 40 of a vehicle, e.g., a car, having anchors 40c and 40d. In this embodiment, system 30 includes infant car seat 32 configured to removably rest on vehicle seat 40a. Strap 34 is interfaced with ICS 32 through first strap-interface 32a. A variety of strap-interfaces may be used, and interfacing may be performed in a variety of ways to maintain the ICS in a desired positioned. In the embodiment shown, strap-interface 32a includes a pair of apertures 32a defined in the ICS, and strap 34 is interfaced by being thread through apertures 32a.

Strap 34 includes first part 34a and second part 34b. Clip 36a is connected to first part 34a, and clip 36b is connected to second part 34b. Clips can have a variety of sizes and constructions but will be configured to interface with at least one anchor of a car seat, e.g., anchor 40c. Although two clips are shown, other embodiments may include more or fewer clips.

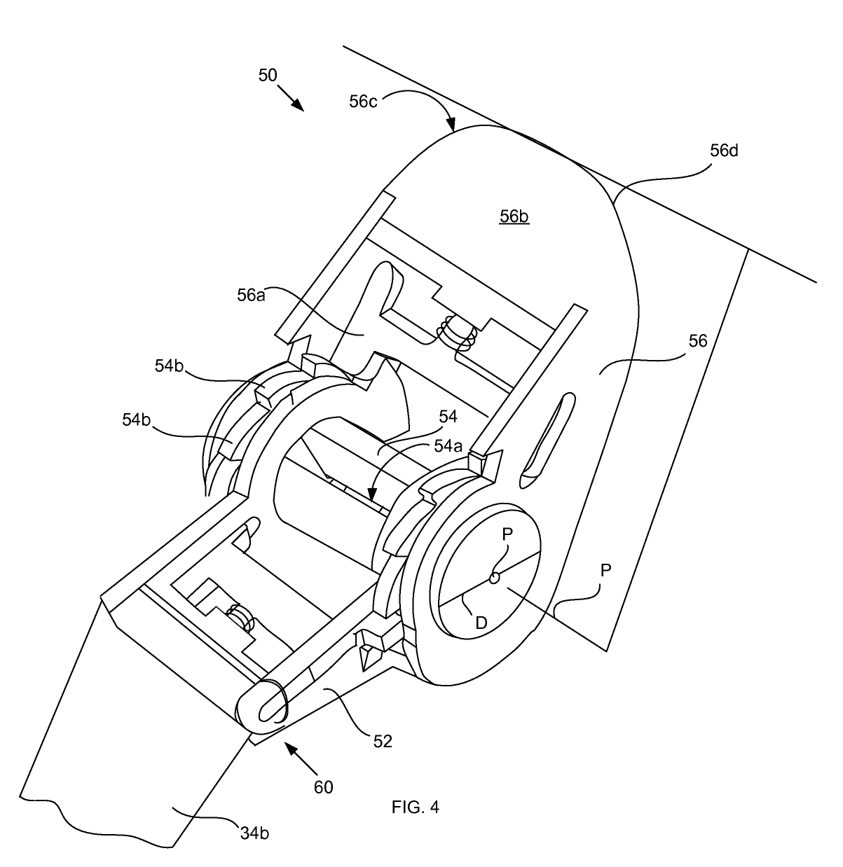

Ratchet tightener 50 (also referred to as “RT”) is operably positioned in between clip 36a and ICS 32. In other embodiments, RTs may be positioned in other places. As seen in FIG. 3, RT 50 is in the closed position. FIG. 4 shows a close up, isolated view of one embodiment of an RT, RT 50, in an open position. Referring primarily to FIG. 4, RT 50 includes body 52 and lever 56 pivotally connected to body 52 to pivot about an axis P extending through point P. Strap shaft 54 is rotatably mounted with body 52 and is in rotatable communication with a plurality of pawls 54b.

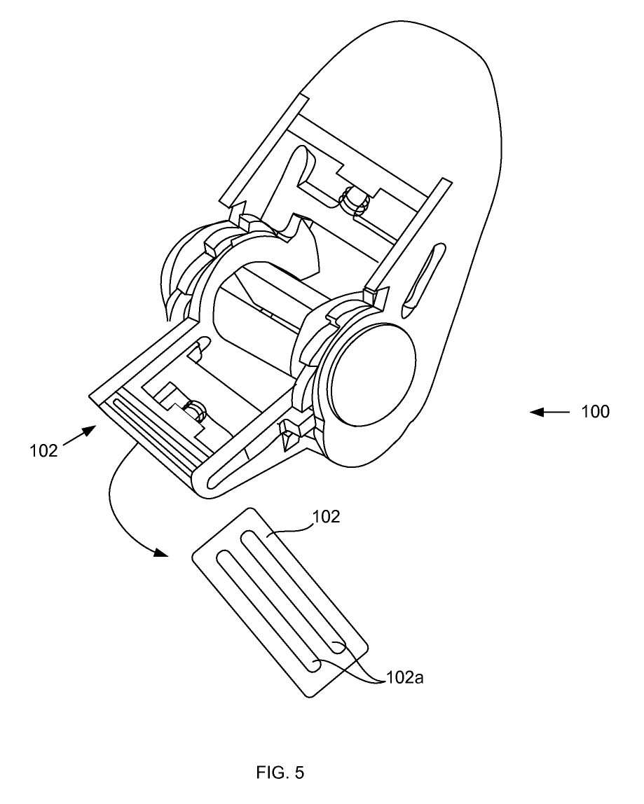

Strap shaft 54 is also interfaceable with a portion of a strap, e.g., first part 34a of FIG. 3. In typical embodiments, strap interface is achieved by sliding a portion of a strap through slot 54a, but in other embodiments, interface may be achieved in other ways. Body 52 also includes second strap-interface 60, interfaceable at one end with another portion of a strap, e.g., portion 34b. In the embodiment shown, strap 34b is fixedly mounted to body 52 at strap-interface 60, but in other embodiments, e.g., embodiment 100 shown in FIG. 5, second strap-interfaces may be configured for adjustable mounting. In this embodiment, for example, a strap may be secured through slots 102a of strap-interface portion.

Lever 56 includes bottom surface 56b, top surface 56c (opposite bottom surface), and drive 56a, which is typically biased, e.g., by a spring to engage pawls 54b. When the lever is moved through its pivotal motion, drive 56a drives the strap shaft, thereby producing a tension.

As noted above, straps of the claimed system interface with the strap-interface of the ICS. Strap-interfaces of the system will have a breaking strength, which is the force at which the strap-interface fails when a tension is applied by a strap interfaced with the strap-interface. As used herein, strap-interface failure includes the failure of any part of the ICS, e.g., a failure at the base, the back, or any part connected to the strap-interface. Data regarding manufacturing materials may be used to estimate breaking strength. For example, ICSs are commonly made from a plastic, e.g., polypropylene, and such material data can be used to estimate breaking strength. Additionally, a breaking strength test, i.e., tightening a strap having a tension scale positioned between the RT and the ICS until strap-interface failure, may be used to determine the breaking strength.

In many embodiments, RTs will be configured to generate a tension under the breaking strength of the strap-interface. RTs may be configured to achieve this result in a variety of ways. For example, RTs may have components, e.g., shear pins or other shearing parts, designed to fail prior to the breaking strength of the strap-interface. In many embodiments, RTs will have a lever length L configured to prevent the strap shaft from generating a tension above the breaking strength of the strap-interface when operated using a key pinch grip (i.e., the thumb pad to the lateral aspect of the middle phalanx of the index finger). Although key pinch grip strength may vary from user to user, typical maximum strengths range from about 10 to about 40 across a variety of age groups, with more typical strengths ranging from about 15 to about 30 (measured using, for example, a B&L pinch gauge). Applicant believes a lever lengths chosen from about 1 inch to about 2 inches will be suitable for providing sufficient results based on maximum key pinch grip strengths. In various embodiments, levers of additional sizes may be used.

In many embodiments, the RT will be configured to allow the lever to pivot without contacting a backrest of the car's seat. This configuration may be achieved by placing the RT the requisite distance away from the car seat, or may be achieved by selecting a lever length L that can pivot over its full range of motion without contacting the car seat. In at least one embodiment, the strap shaft has a diameter D, and L is equal to about D to about 3D.

In some embodiments, the top surface of the lever 56c is configured to prevent access to biased drive 56a when the RT is in the closed position. Such a configuration reduces the unintentional release of the biased drive from the plurality of pawls. Additionally, such a configuration will often require that the lever be at least partially pivoted away from said body to unbais the drive and release the drive from the plurality of pawls. In one such embodiment, the top surface of the lever is solid to prevent access to the biased drive.

In many embodiments, the lever will also be rounded at edge 56d as shown. In at least one embodiment, the lever will also include a rubberized or cushioned finish to reduce damage to seating and scratching.

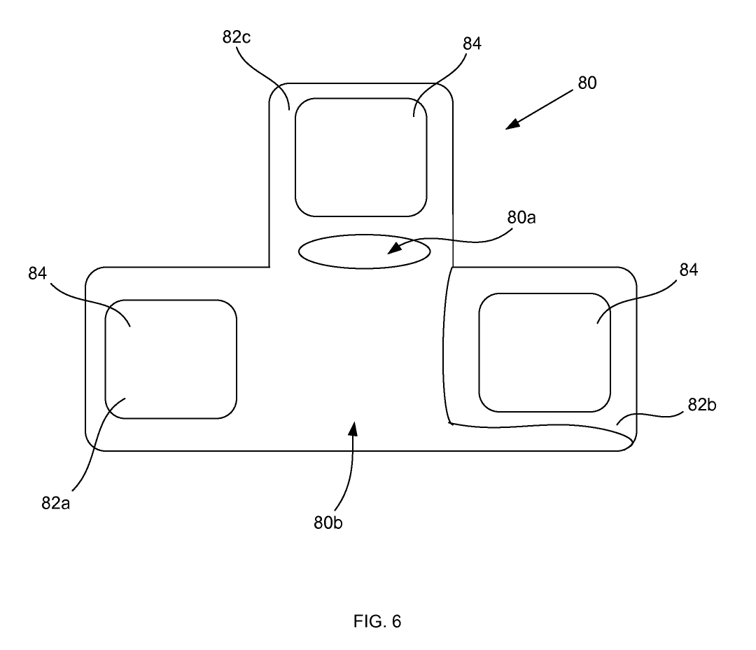

Embodiments may also include a cover 80 (FIG. 6) configured to cover the RT. Covers can be used to secure the RT and reduce or prevent unintentional operation of the RT. In the embodiment shown cover 80 defines slot 80a configured to receive a strap, and includes two side arms 82a and 82b and a top arm 82c. Fasteners 84 are included on at least one arm. A variety of fasteners can be used, but most typically, fasteners will include hook and loop components configured to mate. Commonly, each arm will include at least one fastener 84 as shown. To apply the cover, for example, a strap of the system may be inserted through slot 80a. After the RT is operated to the desired extent, the RT is nestled into portion 80b of the cover. Arm 82b is folded over the RT, then arm 82a is folded over the RT such that fasteners 84 mate. Arm 82c may then be folded down onto folded arm 82a to mate with another fastener 84 positioned on arm 82a (not shown). The result is a secured RT that resists unintentional operation. A variety of other cover embodiments and folding configurations may be used.

In terms of operation, systems and components of the invention can be used to quickly and easily install and secure ICSs. The configuration of the ICS reduces potential damage to the ICS and improves safety. ICSs can also be easily removed, in many embodiments, simply by releasing the drive of the RT.

Numerous characteristics and advantages have been set forth in the foregoing description, together with details of structure and function. The disclosure, however, is illustrative only, and changes may be made in detail, especially in matters of shape, size, and arrangement of parts, within the principle of the invention, to the full extent indicated by the broad general meaning of the terms in which the general claims are expressed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

What is claimed is:

1. An infant seat system for securing to a vehicle seat, said vehicle having at least one anchor, said system comprising:
(a) an infant car seat (ICS) configured to removably rest on said vehicle seat, said ICS having a first strap-interface having a breaking strength;
(b) a strap interfaced with said strap-interface of said seat, said strap having a first part and a second part;
(c) a clip attached to said first part of said strap, wherein said clip is sized to interface with said at least one anchor; and
(d) a ratchet tightener (RT) positioned in between said clip and said infant seat, wherein said RT tightens said strap when operated.

2. The infant seat system of claim 1, wherein said RT includes
(d1) a body having
a strap shaft interfaced with said first part of said strap, and
a second strap-interface interfaced with said second part of said strap, wherein said strap shaft is rotatably mounted in said body and includes a plurality of pawls for driving its rotation, and
(d2) a lever pivotally connected to said body, said lever having
a top surface, and
a biased drive positioned under said top surface, wherein said drive is biased to interface with said plurality of pawls for driving said strap shaft when said lever is moved through its pivotal motion.

3. The infant seat system of claim 1, wherein said RT is configured to generate a tension under the breaking strength of said strap-interface during operation.

4. The infant seat system of claim 2, wherein said lever has a length L configured to prevent said strap shaft from generating a tension above the breaking strength of said strap-interface during operation.

5. The infant seat system of claim 4, wherein said length L is chosen such that a user having a pinch grip strength chosen from about 15, about 16, about 17, about 18, about 19, about 20, about 21, about 22, about 23, about 24, about 25, about 26, about 27, about 28, about 29 and about 30 lbs, is unable to generate a tension above the breaking strength of said strap-interface during operation.

6. The infant seat system of claim 2, wherein said lever has a length L configured to allow said lever to pivot without contacting a backrest of said car's seat.

7. The infant seat system of claim 2, wherein said lever has a length L and said strap shaft has a diameter D, and wherein said L is equal to about D to about 3D, thereby allowing said lever to pivot over a fuller range of motion without contacting a backrest of said car's seat.

8. The infant seat system of claim 2, wherein said top surface is configured to prevent access to said biased drive when said RT is in the closed position, thereby requiring said lever to be at least partially pivoted away from said body to unbais said drive and release said drive from said plurality of teeth.

9. The infant seat system of claim 1, further including cover configured to optionally prevent the operation of said RT.

10. The infant seat system of claim 2, further including cover configured to optionally prevent the movement of said lever relative to said body.

11. The infant seat system of claim 1, wherein said at least one anchor is located in the junction created between the base and backrest of the car's seat.

12. A method of securing a car seat to a vehicle seat, said method comprising:
(a) obtaining an infant car seat (ICS) configured to removably rest on said vehicle seat, said ICS having
a first strap-interface having a breaking strength,
a strap interfaced with said strap-interface of said seat, said strap having a first part and a second part;
a clip attached to said first part of said strap, wherein said clip is sized to interface with said at least one anchor; and
a ratchet tightener (RT) positioned in between said clip and said infant seat, wherein said RT tightens said strap when operated, said RT comprising a lever pivotally connected to a body, wherein said RT is configured to generate a tension under the breaking strength of said strap-interface during operation.

13. The method of claim 12, further including covering the RT to prevent an unintended operation of said RT.
